(19) United States
(12) Patent Application Publication
(10) Pub. No.: US 2011/0295982 A1
(43) Pub. Date: Dec. 1, 2011

(54) SOCIETAL-SCALE GRAPH-BASED INTERDICTION FOR VIRUS PROPAGATION SLOWDOWN IN TELECOMMUNICATIONS NETWORKS

(75) Inventor: Archan Misra, Bridgewater, NJ (US)

(73) Assignee: TELCORDIA TECHNOLOGIES, INC., Piscataway, NJ (US)

(21) Appl. No.: 12/786,961

(22) Filed: May 25, 2010

(51) Int. Cl. G06F 21/00; G06F 15/177

(52) U.S. Cl. 709/220; 726/23

(57) ABSTRACT

Embodiments of the invention enable very rapid intervention on detection of computer network attacks by viruses or other malicious code. Targeted disruption of links between selected nodes in the network is used to hinder the spread of such malicious code. This applies to e-mail and other modes of communication. For instance, identification of and response to an attack may occur within 5-10 minutes instead of the hours or days timescale associated with known signature-based virus protection techniques. Aspects of the invention directly adapt to observed patterns of social contacts and exchanges to provide a substantial increase, e.g., on the order of a 10-fold increase, in the time until a virus affects 70-80% of network users. This provides anti-virus inoculation mechanisms significant time, for instance on the order of 1-2 additional days, before an attack disrupts worldwide communication networks.

### BACKGROUND OF THE INVENTION

1. Field of the Invention

The invention generally relates to the spread of malicious code in computer networks. Aspects of the invention pertain to disrupting communication links that enhance the spread of viruses and other malicious code.

2. Description of Related Art

Viruses, worms and other forms of malicious code constitute a major threat to telecommunication network performance. As wired and wireless networks expand in size and bandwidth, the number of users and the amount of information transmitted across such networks greatly increases. Improved connectivity on mobile landline and wireless networks implies that end hosts can cause very rapid propagation of viruses.

As more and more users experience ubiquitous, “always on” connectivity to the Internet and other networks, the potential for rapid and widespread propagation of viruses becomes increasingly more real, posing a serious challenge to telecommunication networks in general as well as national infrastructure. In many instances, viruses propagate by reading contact lists from consumer devices (e.g., a contact list in a Microsoft Exchange client or a contact list stored on a mobile phone) and auto-generating e-mail to these contacts, or otherwise attaching themselves to user-generated e-mail. Additionally, as communication typically converges on an IP-based transport, viruses can be propagated by piggybacking onto a variety of communication channels, such as short message service (“SMS”), instant messaging (“IM”), voice over IP (“VoIP”), etc. Finally, as advanced mobile phones (e.g., 3G, 4G or beyond) become a dominant mode of client computing, viruses can also spread through physical proximity (e.g., over ad-hoc Bluetooth connections).

Conventional approaches to control the rapid spreading of electronic viruses or malware via communication channels may be generally classified into two broad categories. The first approach is content-oriented. In this approach, the content of messages on the communication network is inspected and such content is matched against known signatures corresponding to malicious content. Known anti-virus software essentially operates on this principle. Some of the techniques to rapidly identify such malicious content include fuzzy detection, Norman sandbox and digital immune system approaches.

However, for this type of approach to be effective, the specific signatures of the malicious content must be known. In practice, this may require anti-virus specialists to analyze the characteristics of identified malicious content and develop appropriate signatures. This type of process often takes a few hours to a few days. Unfortunately, increasingly sophisticated malware technologies can propagate over 90% of the Internet in a few minutes to several hours.

The other general category for preventing virus propagation via communication links is to identify and match unusual, and thereby suspicious, patterns of communication for individual clients (e.g., Latent Dirichlet Allocation techniques). A common example is the broadcast of messages to a user's contact list. Since all such messages may be passed through a provider's email server, it is possible to easily isolate the cases when the same message is sent to, for example, 100 or more persons on the contact list. While such patterns can be pre-specified via static policies or customized to a specific communication activity pattern of a single individual, an important drawback is that it assumes that the virus makes detectable changes in the communication activity pattern. In many instances, especially in an increasingly connected world where people exchange hundreds of emails, SMS messages or audio/video sessions in a day, viruses can exhibit rapid global spread even when they attach themselves solely to legitimate, human-initiated communication. Indeed, viruses themselves are becoming intelligent enough to avoid causing identifiable and repeatable patterns of communication.

While these two categories are examples of application-specific control, typically performed by application servers or end hosts, a third alternative is to perform content inspection on a per-packet or per-flow basis at the communication gateways themselves (e.g., at Internet routers). An illustrative example of this, potentially used for mitigating so-called ‘zero-day’ viruses, uses Intel's Active Management Technology (AMT). Such mechanisms inherently rely on matching virus network traffic patterns to known behavioral anomalies. Moreover, such mechanisms may not easily scale with an increasing volume of network communication (e.g., backbone routers are poised to handle Terabits/sec of data) and also suffer from the aforementioned drawback that they work effectively against previously discovered malware signatures, but may be ineffective against unknown signatures.

Another effective form of protecting against rapid large-scale virus propagation is to employ static attributes to effectively partition the network. For example, if one were to statically restrict all outgoing email from websiteA.com to websiteB.com, then there would be protection against cross-contamination. However, such an approach would be highly disruptive as it would essentially cause communication (email) outages between millions of clients, with very high associated economic and human cost. For example, corporate networks routinely responded to early Internet attacks by isolating their internal networks from the Internet, thereby preventing infection of critical enterprise systems.

Various known solutions require a non-trivial time between the detection of a possible attack and the identification of a content signature or activity pattern associated with the attacking virus. Such approaches simply cannot keep up with the high-speed global communication networks of today such as the Internet or cellular 3G networks. Empirical evidence suggests that progressively sophisticated virus technologies are being developed for even more rapid propagation over large number of geographically dispersed nodes in a communication network. While static approaches may achieve some degree of cyber protection, it may come at a much larger, economically unacceptable, scale of communication disruption. Furthermore, with the gradual rise of mobile phone viruses that spread through proximity contact, pure server-based approaches prove to be inadequate in arresting the spread.

### SUMMARY OF THE INVENTION

Due to the inherent limitations in known virus-limiting schemes, it is desirable to employ new solutions which act proactively to prevent the spread of viruses and other malicious code. Aspects of the invention employ historical societal-scale data to identify the key communication links between individuals whose disruption would statistically slow virus propagation and programmatically disrupt such communication links.

In accordance with one embodiment, a method of disrupting spreading of malicious code across a computer network is provided. The method comprises collecting information on communication patterns between a plurality of nodes of the computer network; constructing a network model of links between selected ones of the plurality of nodes; analyzing the network model to determine a set of links and corresponding pairs of nodes so that disruption of the set of links will statistically increase a duration or extent of propagation of the malicious code; and signaling one or more devices in the network to initiate disruption of the set of links.

In one example, the links are weighted to identify a frequency of communication between corresponding pairs of the nodes. In this case, the network model may be a societal-scale graphical model and the link weights are graphically represented in the societal-scale graphical model.

In another example, the method further comprises receiving an external trigger of a potential malicious code attack. Here, analyzing the network model determines the set of links and corresponding pairs in conjunction with the received external trigger. In a further example, constructing the network model includes evaluating device-specific parameters for client devices at the plurality of nodes of the computer network. In yet another example, constructing the network model includes evaluating different modes of communication among client devices associated with the plurality of nodes of the computer network.

Alternatively, constructing the network model includes evaluating a feature associated with human users controlling client devices. In this case, the feature may be a daily movement pattern of a respective human user. In another alternative, the steps of collecting, constructing and analyzing are performed in a distributed arrangement with a plurality of agents operating over partial or aggregated subsets of the network model.

In another example, signaling the one or more devices includes identifying a specific client device or user account associated with a particular link from the set of links; and requesting that communications to be issued from the specific client device or the user account be delayed for a predetermined period of time. Alternatively, signaling the one or more devices includes identifying a first set of client devices or user accounts associated with a second set of client devices or user accounts; and configuring parameters on one or more server devices to delay or disrupt communication between the first set of client devices or user accounts and second set of client devices or user accounts. Optionally, signaling the one or more devices includes identifying a specific client device or user account associated with a particular link from the set of links; and requesting that communications to be issued from the specific client device or the user account be redirected to a content validation service. In this case, the method may comprise the content validation service performing an inspection of any of the communications received from the one or more devices to determine whether the communications include malicious code.

In another example, signaling the one or more devices includes identifying a specific client device associated with a particular link from the set of links; and instructing the specific client device to delay communications from the specific client device for a predetermined period of time. And in a further example, signaling the one or more devices includes identifying a set of telecommunications network server devices that participate in the establishment of connections or relaying of messaging between a plurality of client devices or user accounts; and instructing the telecommunications network server devices to deny or disrupt attempts to establish connections or relay messages between the plurality of client devices or user accounts.

According to another embodiment, an apparatus for disrupting the spread of malicious code in a computer network is provided. The apparatus comprises memory for storing information on communication patterns between a plurality of nodes of the computer network and processor means operatively connected to the memory. The processor means is configured for constructing a network model of links between selected ones of the plurality of nodes; analyzing the network model to determine a set of links and corresponding pairs of nodes so that disruption of the set of links will increase a duration of propagation of the malicious code; and signaling one or more devices in the network to initiate disruption of the set of links.

In one example, the links are weighted to identify a frequency of communication between corresponding pairs of the nodes. In another example, upon receipt of an external trigger of a potential malicious code attack, the processor means analyzes the network model to determine the set of links and corresponding pairs and signals the one or more devices to initiate the disruption.

In a further example, the processor means is configured to signal the one or more devices by identifying a specific client device or user account associated with a particular link from the set of links and requesting that communications to be issued from the specific client device or the user account be delayed for a predetermined period of time. In another example, the processor means is configured to signal the one or more devices by identifying a specific client device or user account associated with a particular link from the set of links and requesting that communications to be issued from the specific client device or the user account be redirected to a content validation service.

Optionally, the processor means is configured to signal the one or more devices by identifying a specific client device associated with a particular link from the set of links and instructing the specific client device to delay communications from the specific client device for a predetermined period of time. And in an alternative, the processor means further comprises a content validation service for performing an inspection of communications received from selected client devices to determine whether the communications include malicious code.

### BRIEF DESCRIPTION OF THE DRAWINGS

FIGS. 1A-B illustrate a computer network for use with aspects of the invention.

FIG. 2 illustrates a social network graph for use with aspects of the invention.

FIG. 3 is a flow diagram illustrating aspects of the invention.

FIG. 4 illustrates policy-based modes of communication disruption in accordance with aspects of the invention.

FIG. S illustrates another social network graph for use with aspects of the invention.

### DETAILED DESCRIPTION

Aspects, features and advantages of the invention will be appreciated when considered with reference to the following description of preferred embodiments and accompanying figures. The same reference numbers in different drawings may identify the same or similar elements. Furthermore, the following description is not limiting; the scope of the invention is defined by the appended claims and equivalents.

Embodiments of the invention provide a means to automatically use societal-scale patterns of communication and movement to identify which set of communication links are more critical to rapid virus propagation. In one example, this is done by identifying the edges between hubs in the contact network of email IDs. In response to a trigger for heightened security levels, such embodiments appropriately perturb the communication on these selected links, to preferably significantly delay the rapid spread of the virus (or other malicious code) via the telecommunication network.

To provide a robust platform, it is not necessary to distinguish between normal and malicious behavior on the network; rather aggregate statistical properties of the contact network, constructed from dynamically changing user contact patterns, may be used to slow down the potential spread of the virus by impairing a small fraction of the communication traffic.

As will be described in detail below, aspects of the invention employ finer-grained, dynamically updated information on communication exchanges among social network nodes (e.g., people or client devices) to achieve virus retardation, while ensuring that the communication disruption is restricted to a selected set of links. For instance, intermittent disruption of selected links between nodes may be employed. This desirably takes into account a variety of factors, such as the operating system of the client device, movement patterns of individual users, already-known information about the current set of infected nodes, etc.

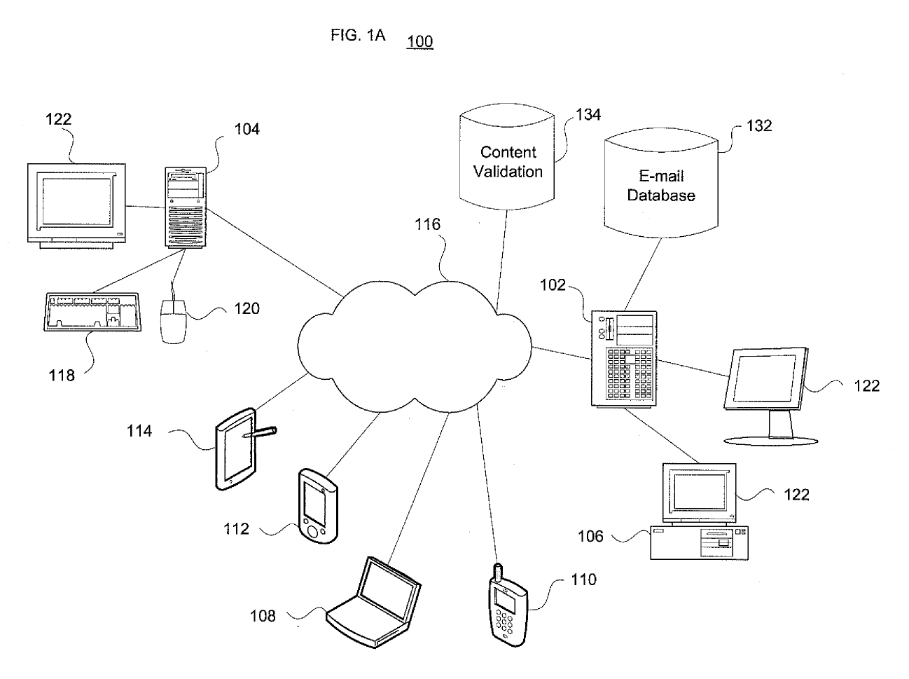

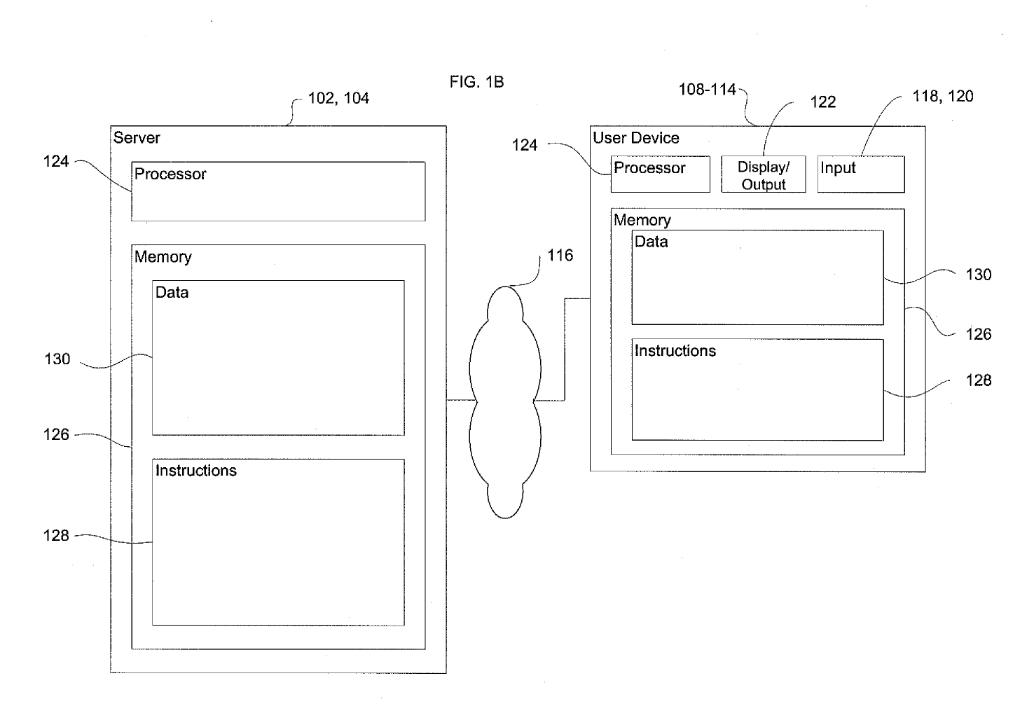

FIGS. 1A-B illustrate an exemplary network configuration for use with aspects of the invention. FIG. 1A presents a schematic diagram of a computer configuration 100 depicting various computing devices. For instance, the configuration 100 may include a plurality of computers 102, 104, 106 and 108 as well as other types of devices such as portable electronic devices including mobile phone 110, multimedia PDA 112 and tablet device 114. Such computing devices may be interconnected via a local or direct connection and/or may be coupled via a communications network 116 such as a LAN, WAN, the Internet, etc. Some or all of the network 116 or connections between certain nodes and devices in the may be wired or wireless.

Each device may include, for example, user inputs such as a keyboard 118 and mouse 120 and/or various other types of input devices such as pen-inputs, joysticks, buttons, touch screens, etc., as well as a display 122, which could include, for instance, a CRT, LCD, touch screen, plasma screen monitor, TV, projector, etc. Each computer 102, 104, 106 and 108 may be a personal computer, server, etc. By way of example only, computers 102 and 104 may be servers, computer 106 may be a personal computer and computer 108 may be a laptop or palmtop device. As shown in FIG. 1B, such devices (as well as mobile phone 110, PDA 112 and tablet device 114) desirably contain a processor 124, memory 126 and other components typically present in a computer. And as shown in FIG. 1A, the network configuration 100 may also include an e-mail database or other social network-related content database 132. A content validation database 134 may also be directly or indirectly coupled to server 102 or server 104. The content validation database 134 may be used to determine whether user communications are infected with a virus or otherwise used to spread malicious code, as discussed in detail below.

Memory 126 stores information accessible by processor 124, including instructions 128 that may be executed by the processor 124 and data 130 that may be retrieved, manipulated or stored by the processor. The memory may be of any type capable of storing information accessible by the processor, such as a hard-drive, ROM, RAM, CD-ROM, Blu-Ray™ disc, flash memories, write-capable or read-only memories. The processor 124 may comprise any number of well known processors, such as processors from Intel Corporation or Advanced Micro Devices. Alternatively, the processor may be a dedicated controller for executing operations, such as an ASIC.

The instructions 128 may comprise any set of instructions to be executed directly (such as machine code) or indirectly (such as scripts) by the processor. In that regard, the terms “instructions,” “steps” and “programs” may be used interchangeably herein. The instructions may be stored in any computer language or format, such as in object code or modules of source code. The functions, methods and routines of instructions in accordance with the present invention are explained in more detail below.

Data 130 may be retrieved, stored or modified by processor 124 in accordance with the instructions 128. For instance, the processor 124 may be configured to create data packets according to the TCP/IP protocol stack. The data may be stored as a collection of data. For instance, although the invention is not limited by any particular data structure, the data may be stored in computer registers, in a relational database as a table having a plurality of different fields and records, XML documents, etc.

The data may also be formatted in any computer readable format. Moreover, the data may include any information sufficient to identify the relevant information, such as descriptive text, proprietary codes, pointers, references to data stored in other memories (including other network locations) or information which is used by a function to calculate the relevant data.

Although the processor 124 and memory 126 are functionally illustrated in FIG. 1B as being within the same block, it will be understood that the processor and memory may actually comprise multiple processors and memories that may or may not be stored within the same physical housing or location. For example, some or all of the instructions and data may be stored on a removable CD-ROM and others within a read-only computer chip. Some or all of the instructions and data may be stored in a location physically remote from, yet still accessible by, the processor. Similarly, the processor may actually comprise a collection of processors which may or may not operate in parallel. Data may be distributed and stored across multiple memories 126 such as hard drives or the like.

In one aspect, server 102 communicates with one or more client computers 104, 106 and/or 108, as well as devices such as mobile phone 110, PDA 112 and tablet device 114. Each client computer or other user device may be configured similarly to the server 102, with a processor, memory and instructions, as well as one or more user input devices 118, 120 and a user output device, such as display 122. Each client computer may be a general purpose computer, intended for use by a person, having all the components normally found in a personal computer such as a central processing unit (“CPU”), display, CD-ROM, DVD or Blu-Ray™ drive, hard-drive, mouse, keyboard, touch-sensitive screen, speakers, microphone, modem and/or router (telephone, cable or otherwise) and all of the components used for connecting these elements to one another. Moreover, each client device may include a user interface/application module that receives input from the input devices and provides an output via the display 122 or other means, such as by a sound device such as a speaker or transducer.

The servers, client computers and other devices are capable of direct and indirect communication with other computers, such as over network 116. Although only a few computing devices are depicted in FIGS. 1A and 1B, it should be appreciated that a typical system can include a large number of connected servers and clients, with each different computer being at a different node of the network. The network 116, and intervening nodes, may comprise various configurations and protocols including the Internet, intranets, virtual private networks, wide area networks, local networks, private networks using communication protocols proprietary to one or more companies, Ethernet, WiFi, Bluetooth and HTTP.

Communication across the network, including any intervening nodes, may be facilitated by any device capable of transmitting data to and from other computers, such as modems, routers, etc. Although certain advantages are obtained when information is transmitted or received as noted above, other aspects of the invention are not limited to any particular manner of transmission of information.

Moreover, computers and client devices in accordance with the systems and methods described herein may comprise any device capable of processing instructions and transmitting data to and from humans and other computers, including network computers lacking local storage capability, PDAs with modems and Internet-capable wireless phones such as mobile phone 110. Devices configured with wireless connectivity may include at least one antenna and a transmit and receive chain (transceiver). The specific configuration may depend upon the type of wireless connectivity, e.g., cellular, PCS, Bluetooth, 802.11 wireless LAN, etc.

As discussed above, the spread of viruses and other malicious software among client devices can be highly problematic. Aspects of the invention probabilistically slow down the spread of a known or unknown virus (or other malicious code), using the knowledge of societal scale communication patterns among individuals to identify the critical pathways of such viral spreading. To achieve this, historical data is used to construct appropriate socio-communication network graph models.

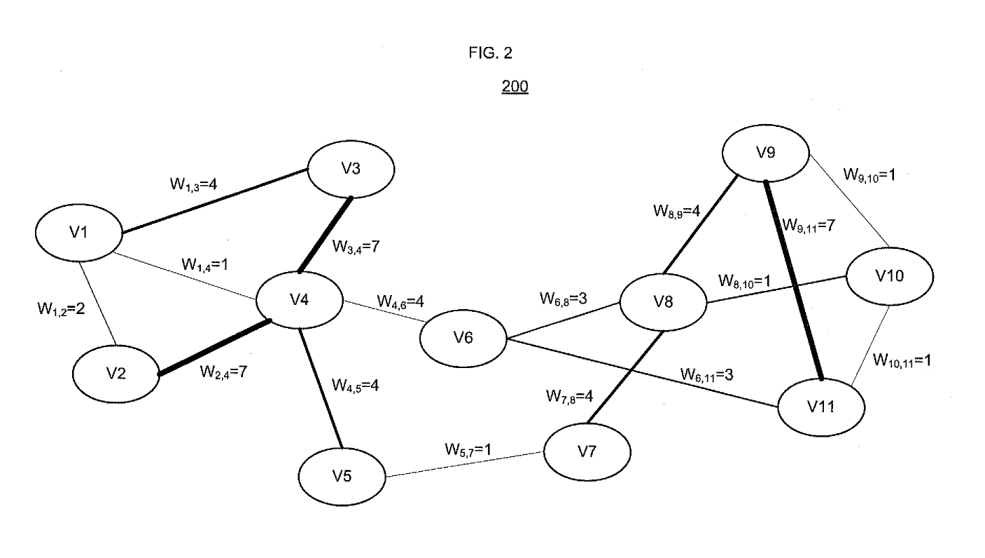

An exemplary socio-communication network graph model 200 is illustrated in FIG. 2. Note that the historical data may be obtained from a variety of network and application sources, such as the calling history of individuals obtained from call detail records (CDRs) or the contact/buddy list for individuals, obtained from email or IM servers, and the movement history of individual devices/persons, which obtained from association records of base stations or other network infrastructure.

As shown in FIG. 2, the individual nodes (V1, V2, . . . , V11) may correspond to different communication endpoint entities (e.g., a person, e-mail ID, sip uniform resource identifiers (URIs) (e.g., sip:user1@abc.com) or client device identifier) and the links correspond to past history of direct communication between corresponding nodes. In the present example, the nodes correspond to e-mail IDs and the weight for each link represents a frequency of e-mail exchanges between the corresponding e-mail ID nodes.

In this example, each line connecting a pair of nodes denotes a direct link between the two nodes. The weight (illustrated as a change in line thickness) on a given link corresponds to the frequency of communication (e.g., e-mails sent by Vi to Vj per week) between the nodes. It can be seen that certain links have thin lines to denote limited communication (e.g., W_{1,4}=1, W_{5,7}=1, W_{10,11}=1) while other lines are relatively thick, denoting substantial communication (e.g., W_{2,4}=7, W_{3,4}=7, W_{9,11}=7).

It is known that social networks possess certain statistical properties such as scale-free topologies and power law degree distributions. It is also known that scale-free network topologies may be robust to random failures while being vulnerable to directed attacks. As will be explained in more detail below, aspects are directed to significantly slowing down the rate of infection by targeting for disruption only a very small fraction of the nodes/links. Thus, in this example, disrupting links such as between nodes 2 and 4, 3 and 4 or 9 and 11 can be used to minimize directed attacks.

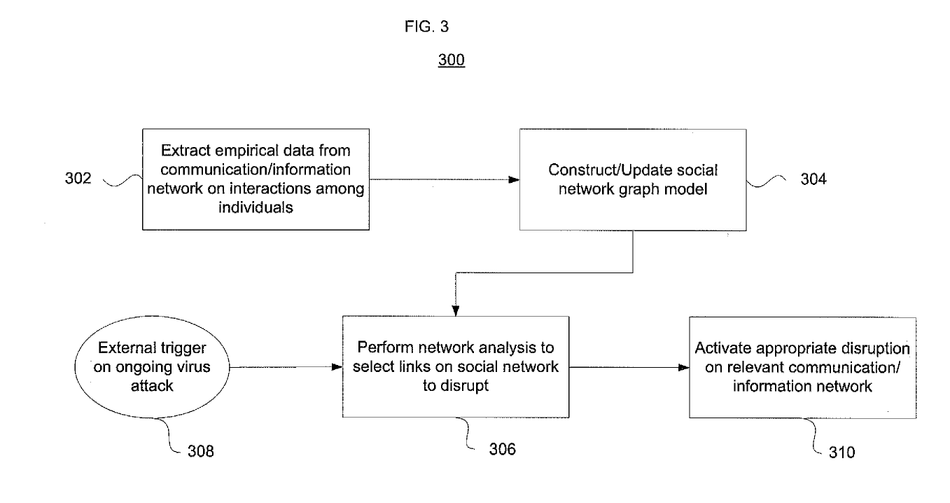

The basic functional steps in the instantiation of this invention are described in flow diagram 300 of FIG. 3. As show, empirical data is collected (block 302) on the social interactions or contacts, as appropriate, among individuals who are communicating using the communications infrastructure. This may involve incorporating appropriate probes or sensors on either personal devices, infrastructure servers or along the path of specific communications-related workflows. For example, the contact list of an individual device may be integrated into an e-mail client on the device and can be retrieved via the use of telecommunications software such as Device Director by Telcordia. The Device Director may also be used to determine various device-specific parameters, such as the operating system (“O/S”) type (e.g., Microsoft Windows vs. Apple's O/S) or the O/S version number.

Alternately, in many instances, the contact list may be maintained on an infrastructure server—for example, a Microsoft Exchange e-mail server, and may be retrieved by issuing queries through appropriately authorized interfaces. Likewise, the frequency of communication such as audio or video IP-based calls or the frequency of e-mail messages between individuals can be obtained through appropriate inspection of the corresponding CDRs or session detail records (SDRs) in a telecom service provider network. This data may desirably be collected in a semi-continuous fashion at appropriate intervals (e.g., ranging from once per day to once per month).

The collected information is then provided to a module (block 304) that is able to utilize this data to build a corresponding complex network model (e.g., multimodal graphs in a societal-scale graphical model), an exemplar of which was illustrated in FIG. 2. The particular techniques used to build this model may require either the entire set of social interaction and user-specific data at the same time or may employ incremental model building processes that are able to refine the model as progressively more data is made available by the instrumentation process from block 302.

For instance, mobility patterns of users' client devices may also be examined when constructing the model. Here, the client devices may be 3G or 4G mobile phones capable of communicating via e-mail, SMS messaging, MMS messaging, instant messaging, voice-over-IP and accessing web pages in addition to voice calls. A client device may move about a network and may communicate with different nodes using different modes of communication. By way of example only, the user of a given client device may communicate with a first group of people via e-mail, communicate with a second group of people via instant messaging, and a third group of people via SMS messaging. Different malicious code may be spread to the different groups (or particular types of client devices) by the different types of communication. Such information is useful when preparing the complex network model.

The resultant social network data is input into a module for network analysis and link disruption identification, as shown in block 306. Here, network analysis and link disruption identification may itself be invoked in an event-triggered fashion, for instance upon the generation/triggering of an alert or alarm (block 308) of a possible ongoing virus attack. This alert may itself be triggered by a variety of external mechanisms, such as the issuance of a particular level of warning by a government-controlled national infrastructure monitoring center or the issuance of specific ongoing attacks by a commercial anti-virus company.

The module 306 configured to perform network analysis may apply a variety of network science analytical techniques to identify a set of link or nodes that need to be (or can be) disrupted. The exact form of such disruption can be of various kinds, as described herein. Note that the set of links to be disrupted is based on a variety of analytic algorithms. Well-known exemplars of such algorithms include the selective removal/disruption of all the edges belonging to nodes with the largest degree (i.e., the largest number of links), as discussed by Albert et al., “Error and Attach Tolerance of Complex Networks,” Nature 406, 378-482 (2000), links associated with nodes with the highest sequential “betweenness” values,” as discussed by Holme et al., “Attach Vulnerability of Complex Networks,” Phys. Rev. E, Vol. 65, No. 5, American Physical Society (2002), and preferential removal of shorter (with smaller edge weights) over longer links, as discussed by Lai et al., “Attacks and Cascades in Complex Networks,” Lecture Notes in Physica 650, 299-310.

In certain social network topologies such as highly assortative networks, where social hubs tend to connect to one another preferentially, disabling all communication between hubs may be the most effective virus propagation retardation strategy. In other social network topologies such as low assortative networks, where hubs typically connect largely to other non-hubs, the more useful approach may be to disable communication among so-called “weak links” (links that tend to go between clusters instead of within a cluster).

The availability of additional consumer attributes, such as the frequency of communication among individuals, the O/S used on an individual client device or the predicted movement pattern of the client device, may be also used to further refine the process of link identification. For example, if the virus is suspected to be afflicting a particular type of O/S, then inter-hub communication links can be identified for disruption if both ends of the links employ devices using the same O/S.

A particularly interesting aspect of the spread of viruses on mobile communication infrastructures is that viruses may be spread through an electronic proximity network (e.g., transmission of MMS messages to entries in the contact list) or a physical proximity network (e.g., via Bluetooth, as the user of the phone moves around). Accordingly, certain links may be preferentially selected as those associated with nodes having high mobility in an attempt to prevent the rapid physical spread of the virus.

Another important aspect is that the steps of collection of the empirical data (block 302), the construction of the network graph model (block 304) and the subsequent network analysis (block 306) may be performed in a distributed and decentralized fashion. In particular, it is possible, and often likely, that the users of the overall network infrastructure are associated with different service providers (ISPs) and that the ISPs, for reasons of privacy, may not be willing to reveal the details of intra-ISP communication patterns (internal communications between users of the same ISP) to external ISPs.

In this case, as shown in example 500 of FIG. 5, the graph model may be constructed partially by each independent ISP (e.g., ISP_{A}, ISP_{B} or ISP_{C}), and the analysis techniques of each ISP apply only on the subset of the overall network graph model that it is visible to that ISP. For example, ISP_{A} will be aware of links between (V4, V6) and (V4, V5); however, it will also “advertise” that V4 is its most “intra-ISP centrality” user. Likewise, ISP_{B} may advertise that V8 is its user with the highest intra-ISP centrality. Based on this knowledge, the ISPs may apply distributed logic and infer that disrupting “V4 to V6” and “V6 to V8” links may have a significant ability to retard the propagation of the virus.

Known methods for distributed analysis of hubs, and identification of links for disruption, may be used, for instance Hierarchical Linear Models (HLM) as discussed by Raudenbush and Bryk, “Hierarchical linear models: applications and data analysis methods,” Sage Publications, 2nd edition (2002) that may be used to approximately construct and analyze network usage data in a distributed fashion.

Another exemplary method for distributed identification may be the exchange among ISPs of the identity of the nodes (user IDs) that have highest centrality measures within their individual networks. By combining such limited knowledge with more detailed knowledge of the communication by all users across the different ISP networks, it may be possible to identify the links most likely to cause significant global disruption to inter-ISP virus propagation. While such approximation techniques may turn out to be less accurate than a solution where a centralized analysis tool has access to all the collected historical usage information, they may offer a more practical deployment alternative in scenarios where individual service providers are unwilling to share detailed information about their subscriber's intra-network communication patterns.

Next, as shown in block 310, the set of identified links is desirably fed into a disruption enablement module that is configured to interact with corresponding communication or information network infrastructure to disrupt the selected links. Such disruption could be performed at the application level (e.g., at outgoing email servers) or at the network level (e.g., at appropriate signaling points in the telecom infrastructure). In addition, the disruption may be user-specific, for instance to disrupt all communication from one user to another user, or device-specific so as to disrupt communication by the user from their phone, but not from his/her home desktop PC.

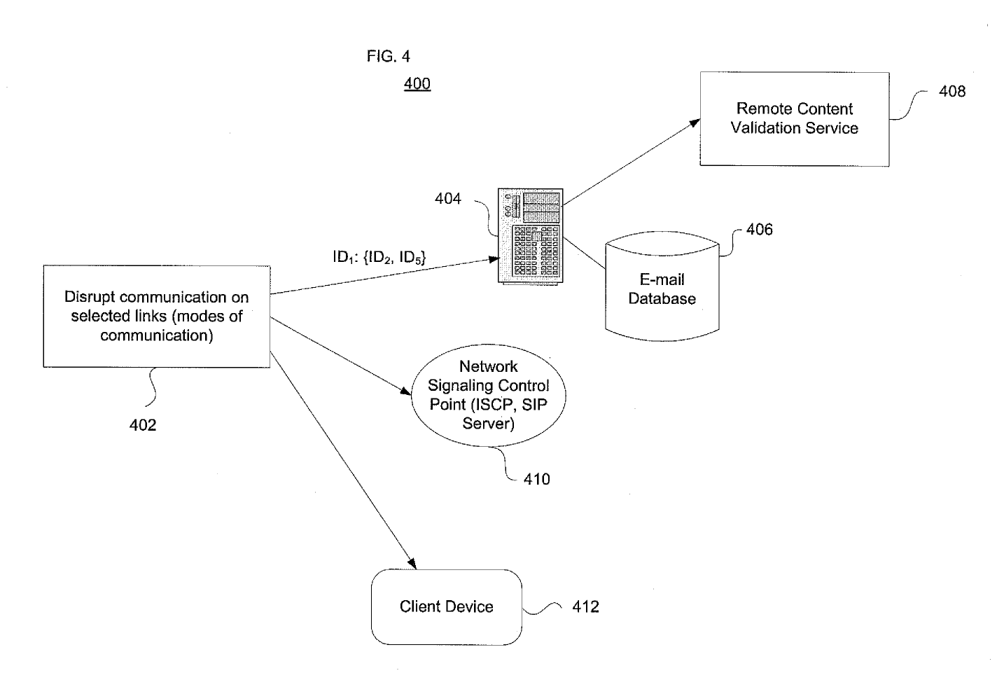

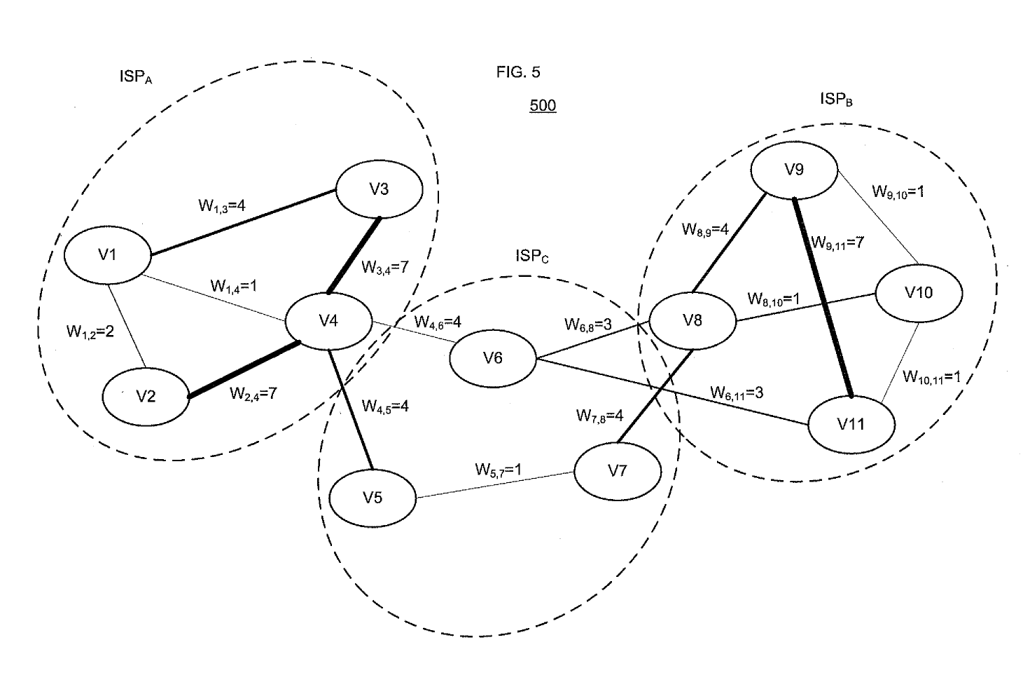

FIG. 4 illustrates an exemplary overview 400 showing certain types of dynamic disruption that can be affected at various nodes and layers of the communication stack. Disruption enablement module 402 may, for example, operate by dynamically signaling a network entity such as e-mail server 404, providing it with a list of e-mail IDs (e.g., ID₂ and ID₅) of two users, and associating with a third user ID (e.g., ID₁). As shown, the e-mail server 404 may be operatively coupled to e-mail database 406.

In this example, the e-mail server may set up a dynamic black/greylist for ID₁ having e-mail IDs ID₂ and ID₅ so that all e-mail communication between ID₁ and {ID₂, ID₅} is delayed for a determined period of time (e.g., for 30 minutes, 2 hours, 48 hours, etc.) by the server 404. Alternately, the server 404 may be configured to redirect the e-mails between these selective set of end-points to a content validation service 408 such as a third party Web service from an anti-virus provider that provides verification of e-mail content. The content validation service 408 is configured to perform deep packet inspection to ensure that e-mail messages are virus-free. Desirably, only a very small fraction (e.g., less than 1-2%) of the overall traffic is subject to such disruption or inspection; otherwise, it may be challenging to scale to the hundreds of millions of e-mail exchanges among hundreds of millions of consumers every day.

Another form of disruption may be achieved by appropriately communicating some disruption directive to a signaling control point 410 in the communication network from the disruption enablement module 402. Examples of such control points in telecommunication networks includes Integrated Service Control Points (“ISCPs”), used for signaling in converged networks) and SIP proxies used as signaling control points in an IP Multimedia Subsystem or IMS framework. In one embodiment, a set of {source, destination} SIP tuples as well as a set of session types is provided to the signal control point 410 to identify an action to be restricted, blocked or forbidden from taking place in the telecommunication network. For example, the directive from the disruption enablement module 402 may specify that instant message (“IM”) traffic from sip:a@abc.com to sip:z@abc.com should be prohibited for the next 2 hours, blocked completely or routed to the content validation service 408 for analysis.

FIG. 4 also illustrates another form of interdiction that can be achieved, especially when consumers use a client device 412, such as a 3G or 4G mobile phone, as an endpoint of communication. The disruption enablement module 402 may signal a specific client device (e.g., the mobile phone) to either turn off its wireless (e.g., Bluetooth) interface or prohibit traffic over that interface for a specified time duration. In one example, this may be done if it is predicted that the client device 412 will be carried in a crowded area such as a train compartment, when it is in close contact to a large number of other mobile devices, with a goal of reducing the probability of proximity-based spread of a virus.

As discussed herein, aspects of the invention exploit the nature of social network interconnections, between humans on a communication network, to express policies on the communication network. Systems and methods desirably continually update the properties of the social network based on evolving human communication patterns, as discovered from telecommunication network usage data. A combination of disruption mechanisms, including server-based, network signaling-based and device-based actions, may be employed to prevent the spread of viruses or other malicious code via multiple modalities of electronic and physical interaction.

While it may be extremely difficult if not impossible to totally prevent the spread of a virus, by performing targeted disruption it is possible to slow down virus propagation in communication networks. Targeted disruption may effectively alter the structure of the societal network through appropriate modification of the signaling functions in the communication network. For instance, link disruption may be viewed as a way to alter the scale-free coefficients of the graph topology.

In some scenarios (see FIG. 3), an external trigger (e.g., an alert issued by a government agency) may be used to alter the degree of disruption the solution would impose on the links of the communication network. In this way, as the severity of the attack is determined, the extent of proactive disruption in the communication links may be adjusted.

By considering multimodal (or multi-attribute) links among the network nodes, aspects of the invention enable and perform communication disruption in a very targeted fashion, thereby significantly limiting the inconvenience caused by such disruption. Testing has shown that disrupting on the order of 1-2% of all communication links may lead to significant increase in the fraction of the overall network (e.g., on the order of up to 80%) that can be shielded from rapid virus infection.

In one configuration, the modules and processes may be employed via a plug-in to e-mail and service providers, such as Microsoft Hotmail, Google mail, Yahoo mail, Verizon e-mail and AT&T e-mail. In another configuration, a telecom infrastructure security assurance product (e.g., patterned on operational centers such as CERT) would allow local, regional or national security agencies to rapidly response to cyber attacks on public (or private) communication infrastructures by coordinating disruption among various Internet and/or cellular service providers (“ISPs”).

Although aspects of the invention herein have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the invention as defined by the appended claims.

While certain processes and operations have been shown in certain orders, it should be understood that they may be performed in different orders and/or in parallel with other operations unless expressly stated to the contrary.

1. A method of disrupting spreading of malicious code across a computer network, the method comprising:
collecting information on communication patterns between a plurality of nodes of the computer network;
constructing a network model of links between selected ones of the plurality of nodes;
analyzing the network model to determine a set of links and corresponding pairs of nodes so that disruption of the set of links will statistically increase a duration or extent of propagation of the malicious code; and
signaling one or more devices in the network to initiate disruption of the set of links.

2. The method of claim 1, wherein the links are weighted to identify a frequency of communication between corresponding pairs of the nodes.

3. The method of claim 2, wherein the network model is a societal-scale graphical model and the link weights are graphically represented in the societal-scale graphical model.

4. The method of claim 1, further comprising:
receiving an external trigger of a potential malicious code attack;
wherein analyzing the network model determines the set of links and corresponding pairs in conjunction with the received external trigger.

5. The method of claim 1, wherein constructing the network model includes evaluating device-specific parameters for client devices at the plurality of nodes of the computer network.

6. The method of claim 1, wherein constructing the network model includes evaluating different modes of communication among client devices associated with the plurality of nodes of the computer network.

7. The method of claim 1, wherein constructing the network model includes evaluating a feature associated with human users controlling client devices.

8. The method of claim 7, wherein the feature is a daily movement pattern of a respective human user.

9. The method of claim 1, wherein the steps of collecting, constructing and analyzing are performed in a distributed arrangement with a plurality of agents operating over partial or aggregated subsets of the network model.

10. The method of claim 1, wherein signaling the one or more devices includes:
identifying a specific client device or user account associated with a particular link from the set of links; and
requesting that communications to be issued from the specific client device or the user account be delayed for a predetermined period of time.

11. The method of claim 1, wherein signaling the one or more devices includes:
identifying a first set of client devices or user accounts associated with a second set of client devices or user accounts; and
configuring parameters on one or more server devices to delay or disrupt communication between the first set of client devices or user accounts and second set of client devices or user accounts.

12. The method of claim 1, wherein signaling the one or more devices includes:
identifying a specific client device or user account associated with a particular link from the set of links; and
requesting that communications to be issued from the specific client device or the user account be redirected to a content validation service.

13. The method claim 12, further comprising the content validation service performing an inspection of any of the communications received from the one or more devices to determine whether the communications include malicious code.

14. The method of claim 1, wherein signaling the one or more devices includes:
identifying a specific client device associated with a particular link from the set of links; and
instructing the specific client device to delay communications from the specific client device for a predetermined period of time.

15. The method of claim 1, wherein signaling the one or more devices includes:
identifying a set of telecommunications network server devices that participate in the establishment of connections or relaying of messaging between a plurality of client devices or user accounts; and
instructing the telecommunications network server devices to deny or disrupt attempts to establish connections or relay messages between the plurality of client devices or user accounts.

16. An apparatus for disrupting the spread of malicious code in a computer network, the apparatus comprising:
memory for storing information on communication patterns between a plurality of nodes of the computer network; and
processor means operatively connected to the memory, the processor means being configured for:
constructing a network model of links between selected ones of the plurality of nodes;
analyzing the network model to determine a set of links and corresponding pairs of nodes so that disruption of the set of links will increase a duration of propagation of the malicious code; and
signaling one or more devices in the network to initiate disruption of the set of links.

17. The apparatus of claim 16, wherein the links are weighted to identify a frequency of communication between corresponding pairs of the nodes.

18. The apparatus of claim 16, wherein upon receipt of an external trigger of a potential malicious code attack, the processor means analyzes the network model to determine the set of links and corresponding pairs and signals the one or more devices to initiate the disruption.

19. The apparatus of claim 16, wherein the processor means is configured to signal the one or more devices by identifying a specific client device or user account associated with a particular link from the set of links and requesting that communications to be issued from the specific client device or the user account be delayed for a predetermined period of time.

20. The apparatus of claim 16, wherein the processor means is configured to signal the one or more devices by identifying a specific client device or user account associated with a particular link from the set of links and requesting that communications to be issued from the specific client device or the user account be redirected to a content validation service.

21. The apparatus of claim 16, wherein the processor means is configured to signal the one or more devices by identifying a specific client device associated with a particular link from the set of links and instructing the specific client device to delay communications from the specific client device for a predetermined period of time

22. The apparatus claim 16, wherein the processor means further comprises a content validation service for performing an inspection of communications received from selected client devices to determine whether the communications include malicious code.
